(19) United States
(12) Patent Application Publication
(10) Pub. No.: US 2008/0084166 A1
(43) Pub. Date: Apr. 10, 2008

(54) Layout configuration of flat display device

(75) Inventor: Tung-Yi Tsai, Taipei (TW)

Correspondence Address: BACON & THOMAS, PLLC, 625 SLATERS LANE, FOURTH FLOOR, ALEXANDRIA, VA, 22314, US

(73) Assignee: JEAN CO., LTD, Taipei (TW)

(21) Appl. No.: 11/979,982

(22) Filed: Nov. 13, 2007

Related U.S. Application Data
(63) Continuation-in-part of application No. 11/067,693, filed on Mar. 1, 2005.

(51) Int. Cl. G09G 3/10; H05B 37/00

(52) U.S. Cl. 315/160

(57) ABSTRACT

The present invention relates to a layout configuration of a flat display device. The flat display device receives an AC power and comprises a display panel and a backlight unit. The layout configuration of the flat displace device comprises a video unit, a backlight driving unit and a power unit mounted on a one-layer printed circuit board and electrically connected to each other via electrical traces of the one-layer printed circuit board. The video unit controls the display panel and has an image data interface circuit, an image data processing and controlling unit, and an image data driving circuit. The backlight driving unit drives the backlight unit for emitting light to the display panel. The power unit is connected to the AC power and has an AC/DC converter and a DC/DC converter for providing power to the video unit and the backlight driving unit.

### CROSS-REFERENCE TO RELATED APPLICATION

This application is a continuation-in-part of U.S. patent application Ser. No. 11/067,693, filed on Mar. 1, 2005, and entitled “LAYOUT CONFIGURATION OF FLAT DISPLAY DEVICE”. The entire disclosures of the above applications are all incorporated herein by reference.

### BACKGROUND OF THE INVENTION

The present invention relates to a layout configuration, and more particularly to a layout configuration of a flat display device. Recently, due to the advantages of thin profile, light weight, low driving voltage and low power consumption, various flat display devices are increasingly developed. The commonly used flat display devices include liquid crystal display (LCD) devices, electroluminescent display (ELD) devices, and vacuum fluorescent display (VFD) devices.

Referring to FIG. 1, a schematic circuit block diagram of a typical LCD device is shown. The LCD device 1 comprises a LCD panel 11, an interface circuit 12, a control circuit 13, a driving circuit 14, a power unit 15 and a backlight unit 16, an inverter 17 and a keypad circuit 18.

The LCD panel 11 comprises a plurality of pixel regions (not shown) arranged in a matrix-type configuration. Each pixel region comprises a capacitor structure and a thin film transistor, and is defined by a crossing of a scan line and a data line. The operation principles of the pixel regions are well known in the art and need not intended to be described redundantly herein.

During operation, the video image data received from the interface circuit 12 is processed by the control circuit 13 to form a signal Sc, and the pixel region of the LCD panel 11 is driven by the signal Sd from the driving circuit 14 connected to the control circuit 13. Via each scan line, all the thin film transistors of the same row are controlled in either a switching-on or switching-off state. Meanwhile, the data lines transmit analog video signals to the switched-on cells electrically connected thereto.

The power unit 15 comprises an AC/DC converter 151 for converting a commercial AC power 10 into a DC voltage. By using a DC/DC converter 152, this DC voltage is converted into desired DC level for the LCD panel 11, the interface circuit 12, the control circuit 13 and the driving circuit 14.

As known, the light source for most flat panel displays is a cold cathode fluorescent backlight. The backlight unit 16 of this LCD device 1 should run on a high AC voltage provided by the inverter 17. The inverter 17 converts the supplied DC power from the AC/DC converter 151 into AC power and steps its voltage up for start-up. Once the backlight unit 16 is started, the inverter 17 drops the voltage down to its operating level. Meanwhile, the backlight unit 16 provides light to the LCD panel 11.

Conventionally, the LCD panel 11 is disposed on the front side of the backlight unit 16. Owing to the voltage differential among the electronic components, the interface circuit 12, the control circuit 13 and the driving circuit 14, the power unit 15, and the inverter 17 are mounted on three separate printed circuit boards (PCBs), so as to ensure electric safety and avoid the interference effects. These PCBs are arranged on the rear side of the backlight unit 16. Please refer to FIG. 2, which schematically illustrates the layout configuration of the PCBs. The left printed circuit board PCB1 has mounted thereon the electronic components of the inverter 17 for dealing with relative high voltage power. The middle printed circuit board PCB2 has mounted thereon the electronic components of the power unit 15 for dealing with power as well. Whereas, the electronic components of the interface circuit 12, the control circuit 13 and the driving circuit 14 are mounted on the right printed circuit board PCB3 for dealing with relative low voltage signals. The keypad circuit 18 is connected to the control circuit 13, and the electronic components of the keypad circuit 18 are mounted on the keypad board PCB4. For clarity, only the circuit block is shown in the drawing.

As shown in FIG. 2, the electronic components mounted on the same printed circuit board are electrically connected to each other via electrical traces. Whereas, every two printed circuit boards are connected to each other via a power cord and corresponding connectors. For example, by plugging the wire L1 into the connectors C3 and C5, the printed circuit board PCB2 is electrically connected to the PCB3 for transmitting the converted DC power from the DC/DC converter 152 to the interface circuit 12, the control circuit 13 and the driving circuit 14. By plugging the wire L2 into the connectors C1 and C6, the printed circuit board PCB1 is electrically connected to the PCB3 for transmitting the converted DC power from the AC/DC converter 151 to the inverter 17. On the other hand, once the wire L3, the power cord L4 and the wire L5 are coupled to the connectors C2, C4 and C7, the printed circuit boards PCB1, PCB2 and PCB3 are electrically connected to the backlight unit 16, the AC power supply 10 and the LCD panel 11, respectively. Via the connector C8 and the signal cable L6, the video image data is transmitted to the interface circuit 12. The keypad board PCB4 is electrically connected to the control circuit 13 of the printed circuit board PCB3 via the wire L7.

The conventional layout configuration of FIG. 2 has some drawbacks. In the conventional layout, the electronic components have to be mounted on individual PCBs according to their voltage differential to maintain electric safety and lower the interference. However, these separated four printed circuit boards PCB1, PCB2, PCB3 and PCB4 occupy much space, which is disadvantage for minimization of the overall LCD device. In addition, many wires and connectors are required to connect the circuits between the printed circuit boards PCB1, PCB2 and PCB3. Conventionally, the wire L2 is relatively longer and flexible. Sometimes it strides across some electronic components of the printed circuit boards PCB2 and PCB3, and thus some interference effects may occur between the power cord and the adjacent electronic components. In order to avoid these adverse effects, it is necessary to have the wire L2 in place. Afterward, too many connectors take much space and are not cost-effective.

### SUMMARY OF THE INVENTION

The present invention provides a layout configuration of a flat display device to reduce complexity and cost for mounting electronic components of the flat display device. In addition, the reduction of interference and the electric safety are also considered in the present invention.

In accordance with a first aspect of the present invention, there is provided a layout configuration of a flat display device. The flat display device receives an AC power and comprises a display panel and a backlight unit. The layout configuration of the flat display device comprises: a video unit controlling the display panel and having an image data interface circuit, an image data processing and controlling unit, and an image data driving circuit; a backlight driving unit driving the backlight unit for emitting light to the display panel; and a power unit connecting to the AC power and having an AC/DC converter and a DC/DC converter for providing power to the video unit and the backlight driving unit; wherein the video unit, the power unit and the backlight driving unit are mounted on a one-layer printed circuit board and electrically connected to each other via electrical traces of the one-layer printed circuit board.

In an embodiment, the one-layer printed circuit board comprises a first layout region, a second layout region, a third layout region, and a fourth layout region. The video unit, the power unit and the backlight driving unit are respectively mounted on the first layout region, the second layout region and the third layout region, and the electrical traces are electrically connected to each other and gathered at the fourth layout region of the one-layer printed circuit board.

In an embodiment, the one-layer printed circuit board further comprises plural clearance regions, the first and second layout regions and the second and third layout regions respectively comprise one of the plural clearance regions disposed therebetween.

In an embodiment, each of the clearance regions comprises at least a gap piercing through the one-layer printed circuit board.

In an embodiment, layout configuration further comprising an audio unit having an audio controller and an audio amplifier, the audio unit is mounted on the first layout region of the one-layer printed circuit board and electronically connected to the video unit and the power unit via the electrical traces gathered at the fourth layout region.

In an embodiment, an audio data is received by the audio controller controlled by the image data processing and controlling unit of the video unit, and the audio data is amplified by the audio amplifier and output to a speaker connected to the audio amplifier.

In an embodiment, the AC power is converted into a DC voltage for the backlight driving unit and the audio unit, the DC voltage is further converted into desired operating DC levels by the DC/DC converter for the video unit.

In an embodiment, the image data interface circuit is electrically connected to the image data processing and controlling unit for receiving a video image data, the video image data is modulated into a video image signal by the image data processing and controlling unit, and the image data driving circuit is electrically connected to the image data processing and controlling unit to generate a video image driving signal in response to the video image signal, so as to control a plurality of pixel regions of the display panel.

In an embodiment, the backlight driving unit is an inverter electronically connected to the AC/DC converter of the power unit and comprises an inverter controller and a switch electrically connected to each other. The inverter controller is controlled by the image data processing and controlling unit, and the switch is connected to the backlight unit for starting the backlight unit.

In an embodiment, the backlight driving unit is a LED driver connected to the AC/DC converter of the power unit and controlled by the image data processing and controlling unit of the video unit for starting the backlight unit.

In an embodiment, the layout configuration further comprises a keypad circuit electrically connected to the image data processing and controlling unit and mounted on the first layout region of the one-layer printed circuit board.

In an embodiment, the one-layer printed circuit board further comprises an extending portion substantially perpendicular to the one-layer printed circuit board, the extending portion mounted a keypad circuit thereon, and the keypad circuit is electrically connected to the image data processing and controlling unit.

In an embodiment, a keypad circuit electrically connected to the image data processing and controlling unit is mounted on a keypad board.

In an embodiment, the image data processing and controlling unit of the video unit further comprises an image data processing circuit and a controller.

In accordance with a second aspect of the present invention, there is provided a layout configuration of a flat display device. The flat display device receives an AC power and comprises a display panel and a backlight unit. The layout configuration comprises an image data interface circuit for receiving a video image data; an image data processing and controlling unit electrically connected to the image data interface circuit for modulating the video image data from the video image data interface circuit to a video image signal; an image data driving circuit electrically connected to the image data processing and controlling unit for generating a video image driving signal in response to the video image signal and output the video image driving signal to the display panel; an AC/DC converter for converting the AC power into a DC voltage; a DC/DC converter for converting the DC voltage into desired operating DC levels for the image data interface circuit, the image data processing and controlling unit and the image data driving circuit; and an backlight driving unit electrically connected to the AC/DC converter for converting the DC voltage into a high AC voltage so as to start the backlight unit. The electronic components of the image data interface circuit, the image data processing and controlling unit, the image data driving circuit, the AC/DC converter, the DC/DC converter and the backlight driving unit are mounted on a one-layer printed circuit board and electrically connected to each other via electrical traces of the one-layer printed circuit board.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram of a typical LCD device;

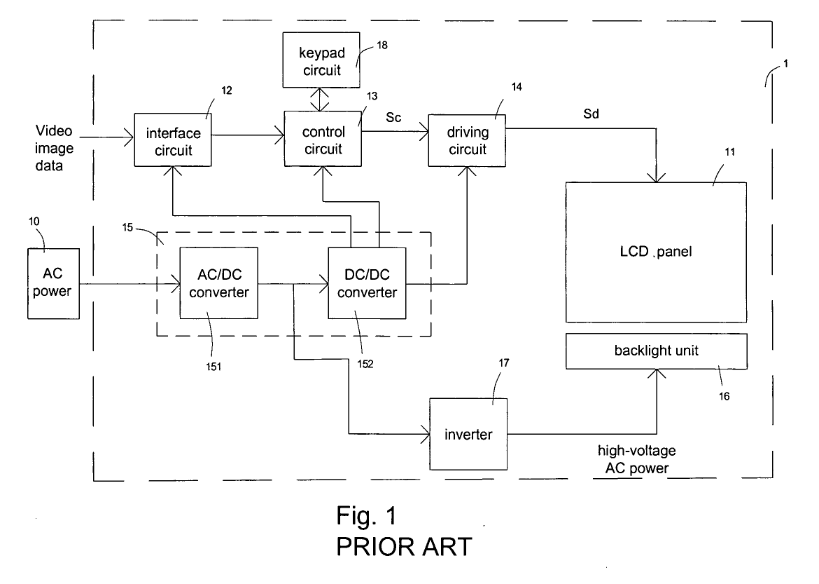

FIG. 2 is a schematic top view illustrates the layout configuration of the LCD device of FIG. 1 according to prior art;

FIG. 3 is a schematic circuit block diagram of the flat display device according to a first preferred embodiment of the present invention;

FIG. 4 is a schematic top view illustrates the layout configuration of the LCD device of FIG. 3 of the present invention;

FIG. 5 is a schematic top view illustrates the layout configuration of a LCD device according to a second preferred embodiment of the present invention; and

FIG. 6 is a schematic top view illustrates the layout configuration of a LCD device according to a third preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

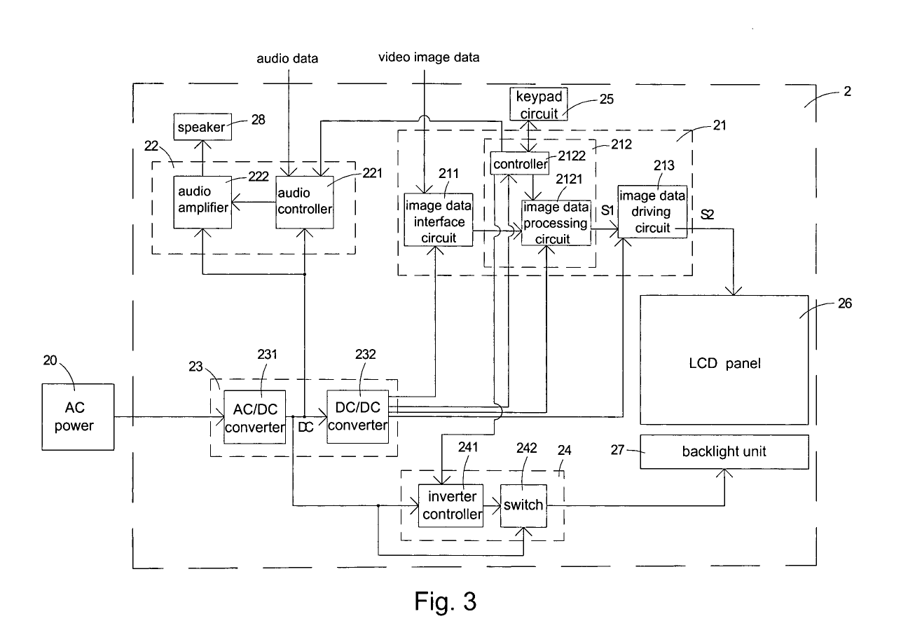

Referring to FIG. 3, a schematic circuit block diagram of the flat display device according to a first preferred embodiment of the present invention is illustrated. In this embodiment, the flat display device is a LCD device 2, but not limited thereto. The LCD device 2 comprises a video unit 21, an audio unit 22, a power unit 23, a backlight driving unit 24, a keypad circuit 25, a LCD panel 26, a backlight unit 27 and a speaker 28, wherein the audio unit 22 is optionally disposed in the LCD device 2. The power unit 23 of the LCD device 2 is connected to a commercial AC power 20 for providing power to the video unit 21, audio unit 22, and the backlight driving unit 24. The power unit 23 comprises an AC/DC converter 231 and a DC/DC converter 232, wherein the AC/DC converter 231 is connected to the commercial AC power 20 for converting AC voltage of the AC power 20 into DC voltage, so as to provide the DC voltage to the audio unit 22 and the backlight driving unit 24. The DC voltage is also transmitted to the DC/DC converter 232 and further being converted into desired DC level for the video unit 21.

The video unit 21 comprises an image data interface circuit 211, an image data processing and controlling unit 212 and an image data driving circuit 213 electrically connected to each other. In some embodiment, the image data processing and controlling unit 212 is a chip with an image data processing circuit 2121 and a controller 2122 electrically connected to each other, wherein the controller 2122 is a microcontroller, but not limited thereto. The image data processing and controlling unit 212 is electrically connected to the keypad circuit 25 through the controller 2122 to receive the messages from user. The controller 2122 of the image data processing and controlling unit 212 controls not only the image data processing circuit 2121, but also the audio unit 22 and the backlight driving unit 24. The video image data received from the image data interface circuit 211 is modulated into a video image signal S1 by the image data processing circuit 2121 of the image data processing and controlling unit 212. In response to the video image signal S1, the image data driving circuit 213 output a video image driving signal S2 to control and drive the pixel region (not shown) of the display panel. In this embodiment, the display panel is a LCD panel 26 with plural pixel regions (not shown), but not limited thereto.

To provide light for the LCD panel 26, a backlight driving unit 24 is used to drive the backlight unit 27, so as to emit light to the LCD panel 26. In this embodiment, the backlight driving unit 24 is an inverter and has an inverter controller 241 and a switch 242 electrically connected to each other. The inverter controller 241 is manipulated by the controller 2122 of the image data processing and controlling unit 212, and the on time of the switch 242 is controlled by the inverter controller 241. Thus the output voltage of the switch 242 can be adjusted, thereby start the backlight unit 27 and regulate the brightness variation of the backlight unit 27 according to the output voltage of the switch 242. Of course, in some embodiments, the backlight driving unit 24 can be a LED driver instead of the inverter, but not limited thereto.

Please refer to FIG. 3 again. An audio unit 22 can be optionally disposed in the LCD device 2. The audio unit 22 has an audio controller 221 and an audio amplifier 222 electrically connected to each other. The AC/DC converter 231 provides the power for the audio controller 221 and the audio amplifier 222. The audio data is received by the audio controller 221 manipulated by the controller 2122 of the image data processing and controlling unit 212, amplified by the audio amplifier 222 and then output to the speaker 28 connected to the audio amplifier 222.

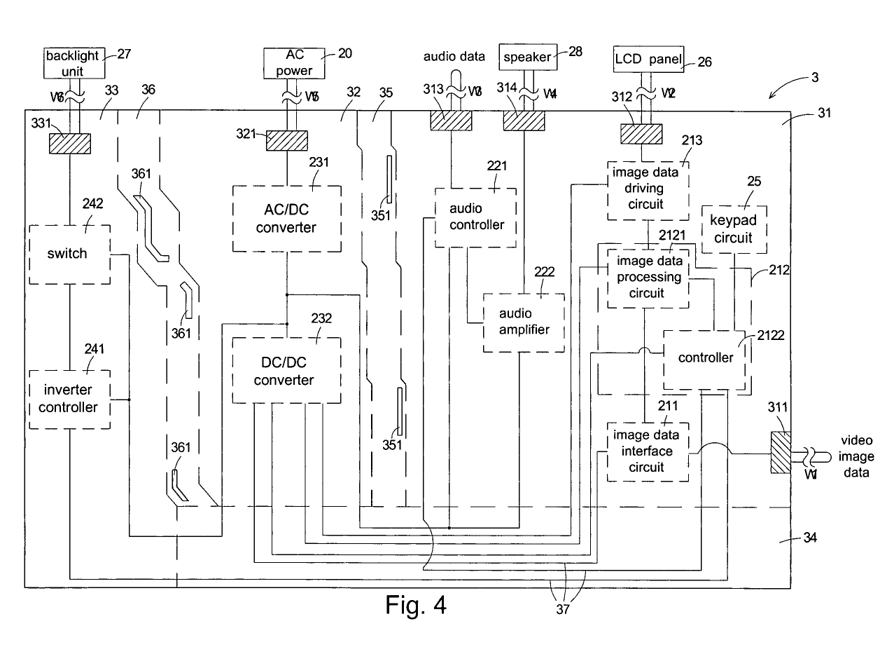

FIG. 4 is a schematic top view illustrating the layout configuration of the LCD device of FIG. 3 of the present invention. Please refer to FIG. 4 and cooperated with FIG. 3, to save cost and reduce complexity for mounting electronic components, the electronic components of the video unit 21, the audio unit 22, the power unit 23, the backlight driving unit 24 and the keypad circuit 25 are mounted on an one-layer printed circuit board 3 in the present invention. In this embodiment, the electronic components can be mounted on one-side of the one-layer printed circuit board 3, but not limited thereto. The one-layer printed circuit board 3 substantially comprises four layout regions 31-34 and two clearance regions 35 and 36. In this embodiment, the first layout region 31, the second layout region 32, the third layout region 33, and the clearance regions 35 and 36 are substantially arranged side by side, whereas the fourth layout region 34 is adjacent to the foregoing regions 31, 32, 33, 35 and 36. In this embodiment, the video unit 21, the audio unit 22 and the keypad circuit 25 for processing low voltage signals are mounted in the first layout region 31 of the one-layer printed circuit board 3. In other words, the image data interface circuit 211, the image data processing and controlling unit 212, the image data driving circuit 213, the audio controller 221, the audio amplifier 222, and the keypad circuit 25 are disposed in the first layout region 31. The video image data is transmitted to the image data interface circuit 211 via the signal cable W1 and the connector 311, and the video image driving signal is transmitted to the LCD panel 26 from the image data driving circuit 213 via the wire W2 and the connector 312. As regards the audio data, it is input to the audio controller 221 through the wire W3 and the connector 313, and the amplified audio signal is output to the speaker 28 via the connector 314 and the wire W4. The AC/DC converter 231 and the DC/DC converter 232 of the power unit 23 for providing power is mounted in the second layout region 32 of the one-layer printed circuit board 3, and the commercial AC power 20 is supplied to the AC/DC converter 231 of the power unit 23 via the power cord W5 and the connector 321. Whereas the backlight driving unit 24 for providing high voltage power to drive the backlight unit 27 is disposed in the third layout region 33 of the one-layer printed circuit board 3. In this embodiment, the backlight driving unit 24 is an inverter having an inverter controller 241 and a switch 242, wherein the switch 242 converts the supplied DC power from the AC/DC converter 231 into AC power and boosts its voltage up for start-up the backlight unit 27 via the connector 331 and the wire W6.

In addition, to space the first layout region 31 and the second layout region 32, a clearance region 35 is disposed between the first and second layout regions 31 and 32. Similarly, a clearance region 36 is disposed between the second layout region 32 and the third layout region 33. In some embodiments, the clearance region 35 further comprises at least a gap 351 piercing through the one-layer printed circuit board 3, and the clearance region 36 comprises at least a gap 361 piercing through the one-layer printed circuit board 3 as well. Since gaps 351 and 361 pierce through the one-layer printed circuit board 3, the isolation ability can be increased owing to the air in the gaps 351 and 361. Therefore, the first, second and third layout regions 31-33 can be isolated by the clearance regions 35 and 36 or further in cooperation with the gaps 351 and 361, so as to ensure electric safety of the LCD device 2 and avoid the damage of the one-layer printed circuit board 3. It is to be understood that the number of the gaps 351 and 361 are not limited; in other words, the number of the gaps 351 and 361 can be adjusted depending on safety demand.

The electronic components of the video unit 21, the audio unit 22 and the keypad circuit 25 mounted on the first layout region 31, the power unit 23 mounted on the second layout region 32, and the backlight driving unit 24 mounted on the third layout region 33 of the one-layer printed circuit board 3 are electrically connected to each other through the electrical traces 37 distributed on one-side of the one-layer printed circuit board 3. To avoid interference among the video unit 21, the audio unit 22 and keypad circuit 25, the power unit 23, and the backlight driving unit 24 with apparent voltage differential, the electrical traces 37 are gathered and electrically connected at the fourth layout region 34 of the one-layer printed circuit board 3. Since the electrical traces 37 are gathered in the fourth layout region 34, the drawbacks of interference effects caused by the conventional layout with wire L2 striding across some electronic components can be prevented. Besides, since the electronic traces 37 do not pass through the clearance regions 35 and 36, the electric safety can be maintained. Of course, in some embodiments of the present invention, for further lowering the interference effects, the ground pads (not shown) can be disposed between the electrical traces 37 at the fourth layout area 34.

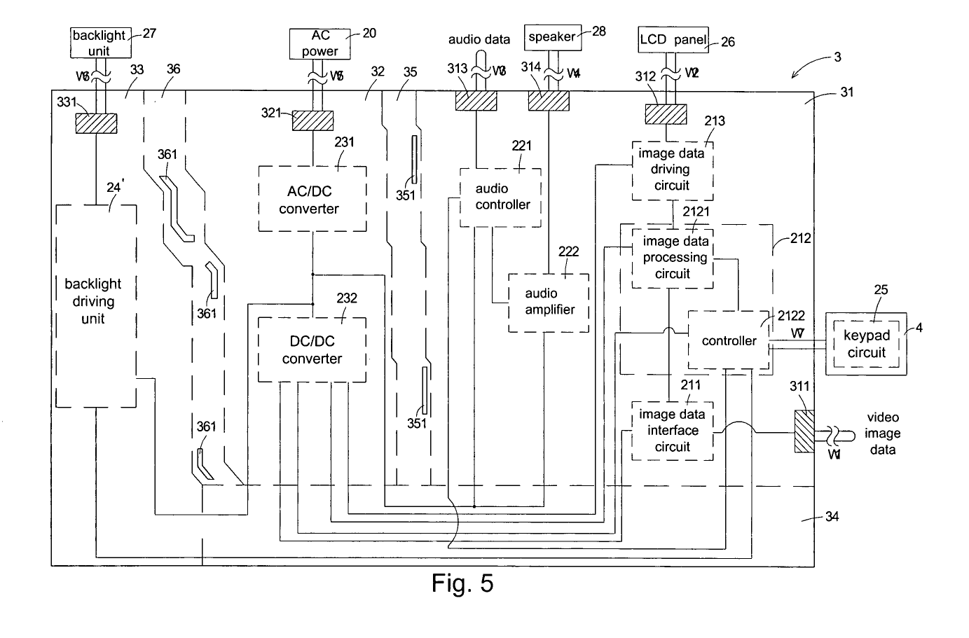

FIG. 5 is a schematic top view illustrating the layout configuration of a LCD device according to a second preferred embodiment of the present invention. The image data interface circuit 211, the image data processing circuit 2121, the controller 2122 and the image data driving circuit 213 of the video unit 21, the audio amplifier 222 and the audio controller 221 of the audio unit 22, and the AC/DC converter 231 and the DC/DC converter 232 of the power unit 23 are similar to those shown in FIG. 4 of the first embodiment of the present invention, and thus it is not redundantly described here. In this embodiment, a LED driver is applied as the backlight driving unit 24′. The backlight driving unit 24′ is controlled by the controller 2122 of the image data processing and controlling unit 212 and electrically connected to the AC/DC converter 231 for converting the DC voltage and transmitting the DC voltage to a LED driving circuit (not shown), so as to start the backlight unit 27 via the connector 331 and the wire W6. In addition, it is noted that, however, those skilled in the art will readily observe that numerous modifications and alterations of the layout configuration may be made while retaining the teachings of the invention. For example, as shown in FIG. 5, the video unit 21, the audio unit 22, the power unit 23 and the backlight driving unit 24′ are mounted on the one-layer printed circuit board 3, while the keypad circuit 25 is mounted on the keypad board 4 and being electrically connected to the controller 2122 of the image data processing and controlling unit 212 through the wire W7.

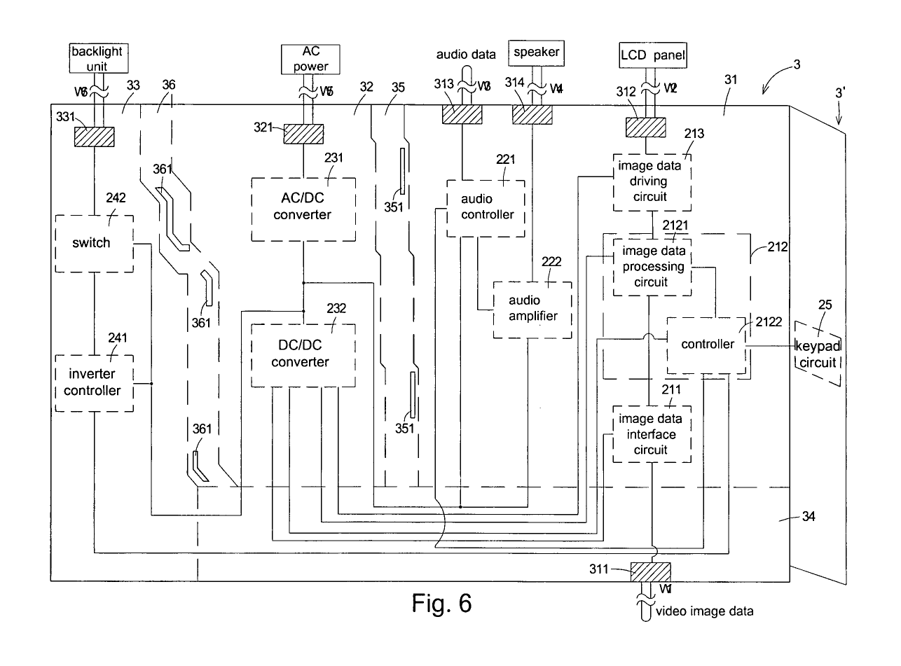

Alternatively, in the third preferred embodiment as shown in FIG. 6, the one-layer printed circuit board 3 further comprises an extending portion 3′ perpendicular to the one-layer printed circuit board 3. The layout of the one-layer printed circuit board 3 is the same as that of the first embodiment shown in FIG. 4 except the keypad circuit 25. In this embodiment, the keypad circuit 25 is mounted on the extending portion 3′ of the one-layer printed circuit board 3.

According to the foregoing description, it is to be understood that the keypad circuit 25 of the first embodiment shown in FIG. 4 can be mounted on the keypad board 4 as shown in FIG. 5. Of course, the LED driver can be mounted on the one-layer printed circuit board 3 shown in FIGS. 4 and 6 as a backlight driving unit 24′ instead of the backlight driving unit 24 being an inverter and comprising the inverter controller 241 and the switch 242.

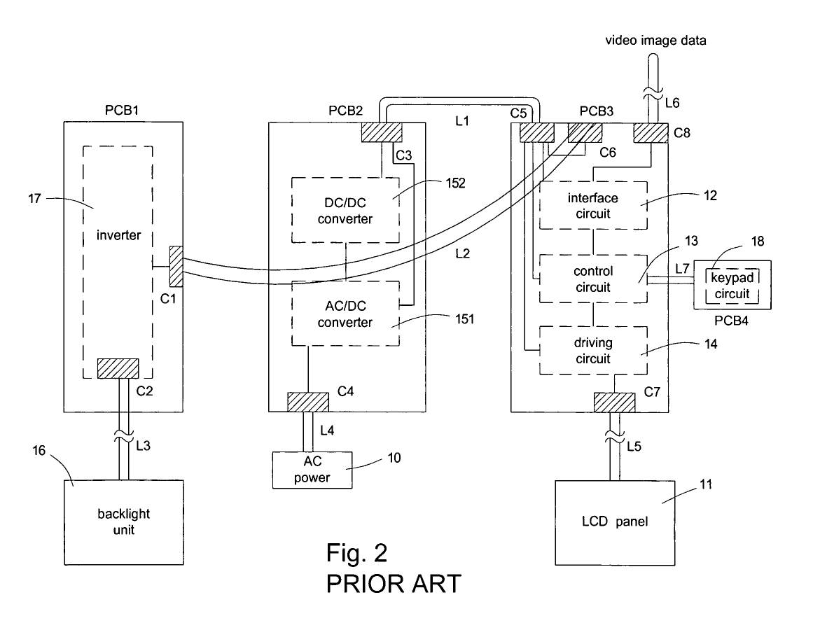

Since the video unit 21, the audio unit 22, the power unit 23, the backlight driving unit 24/24′, and the keypad circuit 25 are arranged on a one-layer printed circuit board 3 with one-layer substrate, the electronic components mounted thereon will be electrically connected to each other via electrical traces 37. In addition, since the electronic components are mounted on the single one-layer printed circuit board 3 by passing a solder machine once, the procedures for connecting PCBs 1-3 by linking the connecters through wires can be omitted. Thus the fabricating process is very convenient. Furthermore, though the connectors 313, 314 and wires W3 and W4 for the audio input and output are added, the wires L1, L2 and the connectors C1, C3, C5 and C6 are exempted from the one-layer printed circuit board 3, when comparing with the layout configuration of FIG. 2. The omission of the wires L1 and L2 avoids the wiring interference caused therefrom and the complex procedure for situating them on a proper place. The omission of the connectors C1, C3, C5 and C6 save the layout space and reduce the overall cost.

Moreover, for maintaining the electric safety and avoiding the interference effects among the electronic components, the interface circuit 12, the control circuit 13 and the driving circuit 14, the power unit 15, and the inverter 17 have to be mounted on individual printed circuit boards PCB1-PCB3 in the convention LCD device 1. While in the present invention, by mounting the video unit 21, the audio unit 22 on the first layout region 31, mounting the power unit 23 on the second layout region 32, mounting the backlight driving unit 24/24′ on the third layout region 33 of the one-layer printed circuit board 3, and isolating these regions with clearance regions 35 and 36, the electric safety can be maintained even all the electronic components are mounted on single one-layer printed circuit board 3. In addition, all the electronic components are electrically connected to each other at the fourth layout region 34 of the one-layer printed circuit board 3 via electric traces 37; hence the electric traces 37 will not pass through the clearance regions 35 and 36 of the one-layer printed circuit board 3. In other words, not only the electric safety can be kept, the interference effects caused by the wire striding across the electronic component can also be overcome.

The above embodiments are illustrated by referring to a layout configuration of a LCD device. Nevertheless, the present invention can be applied to other flat display devices such as electroluminescent display (ELD) devices and vacuum fluorescent display (VFD) devices.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A layout configuration of a flat display device, said flat display device receiving an AC power and comprising a display panel and a backlight unit, said layout configuration comprising:
a video unit controlling said display panel and having an image data interface circuit, an image data processing and controlling unit, and an image data driving circuit;
a backlight driving unit driving said backlight unit for emitting light to said display panel; and
a power unit connecting to said AC power and having an AC/DC converter and a DC/DC converter for providing power to said video unit and said backlight driving unit;
wherein said video unit, said power unit and said backlight driving unit are mounted on a one-layer printed circuit board and electrically connected to each other via electrical traces of said one-layer printed circuit board.

2. The layout configuration according to claim 1, wherein said one-layer printed circuit board comprises a first layout region, a second layout region, a third layout region, and a fourth layout region, said video unit, said power unit and said backlight driving unit are respectively mounted on said first layout region, said second layout region and said third layout region, and said electrical traces are electrically connected to each other and gathered at said fourth layout region of said one-layer printed circuit board.

3. The layout configuration according to claim 2, wherein said one-layer printed circuit board further comprises plural clearance regions, said first and second layout regions and said second and third layout regions respectively comprise one of said plural clearance regions disposed therebetween.

4. The layout configuration according to claim 3, wherein each of said clearance regions comprises at least a gap piercing through said one-layer printed circuit board.

5. The layout configuration according to claim 2 further comprising an audio unit having an audio controller and an audio amplifier, said audio unit is mounted on said first layout region of said one-layer printed circuit board and electronically connected to said video unit and said power unit via said electrical traces gathered at said fourth layout region.

6. The layout configuration according to claim 5, wherein an audio data is received by said audio controller controlled by said image data processing and controlling unit of said video unit, and said audio data is amplified by said audio amplifier and output to a speaker connected to said audio amplifier.

7. The layout configuration according to claim 5, wherein said AC power is converted into a DC voltage for said backlight driving unit and said audio unit by said AC/DC converter, said DC voltage is further converted into desired operating DC levels by said DC/DC converter for said video unit.

8. The layout configuration according to claim 1, wherein said image data interface circuit is electrically connected to said image data processing and controlling unit for receiving a video image data, said video image data is modulated into a video image signal by said image data processing and controlling unit, and said image data driving circuit is electrically connected to said image data processing and controlling unit to generate a video image driving signal in response to said video image signal, so as to control a plurality of pixel regions of said display panel.

9. The layout configuration according to claim 1, wherein said backlight driving unit is an inverter electronically connected to said AC/DC converter of said power unit and comprises an inverter controller and a switch electrically connected to each other, said inverter controller is controlled by said image data processing and controlling unit, and said switch is connected to said backlight unit for starting said backlight unit.

10. The layout configuration according to claim 1, wherein said backlight driving unit is a LED driver connected to said AC/DC converter of said power unit and controlled by said image data processing and controlling unit of said video unit for starting said backlight unit.

11. The layout configuration according to claim 2 further comprising a keypad circuit electrically connected to said image data processing and controlling unit and mounted on said first layout region of said one-layer printed circuit board.

12. The layout configuration according to claim 1, wherein said one-layer printed circuit board further comprises an extending portion substantially perpendicular to said one-layer printed circuit board, said extending portion mounted a keypad circuit thereon, and said keypad circuit is electrically connected to said image data processing and controlling unit.

13. The layout configuration according to claim 1, wherein a keypad circuit electrically connected to said image data processing and controlling unit is mounted on a keypad board.

14. The layout configuration according to claim 1, wherein said image data processing and controlling unit of said video unit further comprises an image data processing circuit and a controller.

15. A layout configuration of a flat display device, said flat display device receiving an AC power and comprising a display panel and a backlight unit, said layout configuration comprising:
an image data interface circuit for receiving a video image data;
an image data processing and controlling unit electrically connected to said image data interface circuit for modulating said video image data from said video image data interface circuit to a video image signal;
an image data driving circuit electrically connected to said image data processing and controlling unit for generating a video image driving signal in response to said video image signal and output said video image driving signal to said display panel;
an AC/DC converter for converting said AC power into a DC voltage;
a DC/DC converter for converting said DC voltage into desired operating DC levels for said image data interface circuit, said image data processing and controlling unit and said image data driving circuit; and
an backlight driving unit electrically connected to said AC/DC converter for converting said DC voltage into a high AC voltage so as to start said backlight unit;
wherein the electronic components of said image data interface circuit, said image data processing and controlling unit, said image data driving circuit, said AC/DC converter, said DC/DC converter and said backlight driving unit are mounted on a one-layer printed circuit board and electrically connected to each other via electrical traces of said one-layer printed circuit board.

16. The layout configuration according to claim 15, wherein said one-layer printed circuit board comprises a first layout region, a second layout region a third layout region and a fourth layout region, said image data interface circuit, said image data processing and controlling unit and said image data driving circuit are mounted on said first layout region, said AC/DC converter and said DC/DC converter are mounted on said second layout region, said backlight driving unit are mounted on said third layout region, and said electrical traces are electrically connected to each other and gathered at said fourth layout region of said one-layer printed circuit board.

17. The layout configuration according to claim 16, wherein said one-layer printed circuit board further comprises plural clearance regions, said first and second layout regions and said second and third layout regions respectively comprise one of said plural clearance regions disposed therebetween.

18. The layout configuration according to claim 17 wherein each of said clearance regions comprises at least a gap piercing through said one-layer printed circuit board.

19. The layout configuration according to claim 16 further comprising:
an audio controller for receiving an audio data; and
an audio amplifier electrically connected to said audio controller for amplifying said audio data and output said audio data to a speaker;
wherein said audio controller and said audio amplifier are mounted on said first layout region of said one-layer printed circuit board, said audio controller is electrically connected to said AC/DC converter and said image data processing and controlling unit via said electric traces gathered at said fourth layout region, and said audio amplifier is electrically connected to said AC/DC converter via said electric traces gathered at said fourth layout region.

20. The layout configuration according to claim 15 further comprising a keypad circuit connected to said image data processing and controlling unit of said video unit.
